(19) United States
(12) Patent Application Publication
(10) Pub. No.: US 2009/0211133 A1
(43) Pub. Date: Aug. 27, 2009

(54) Zero Maintenance Solar Powered Street Sign

(76) Inventor: David A. Neeff, Haddonfield, NJ (US)

Correspondence Address: David A. Neeff, 116 Buckner Ave, Haddonfield, NJ, 08033, US

(21) Appl. No.: 12/146,347

(22) Filed: Jun. 25, 2008

Related U.S. Application Data
(60) Provisional application No. 60/936,904, filed on Jun. 25, 2007.

(51) Int. Cl. G09F 13/04

(52) U.S. Cl. 40/578; 40/564

(57) ABSTRACT

Zero Maintenance Solar Powered Street Sign—A lighted corner street sign with: solar panel film, ultracapacitors and LEDs whereas the sign does not require maintenance for ten years. Invention provides all features but does not use batteries, switches, photoelectric sensors, resistors, etc. Eliminating the use of conventional battery technology is exploited in many ways. Ultracapacitors provide new advantages.

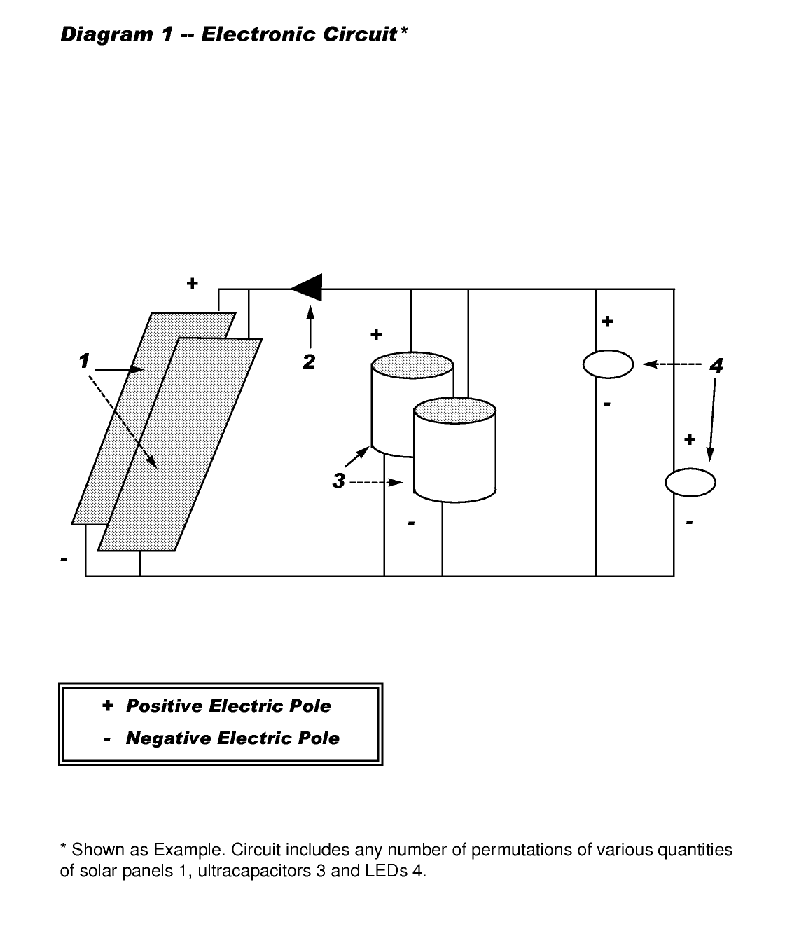

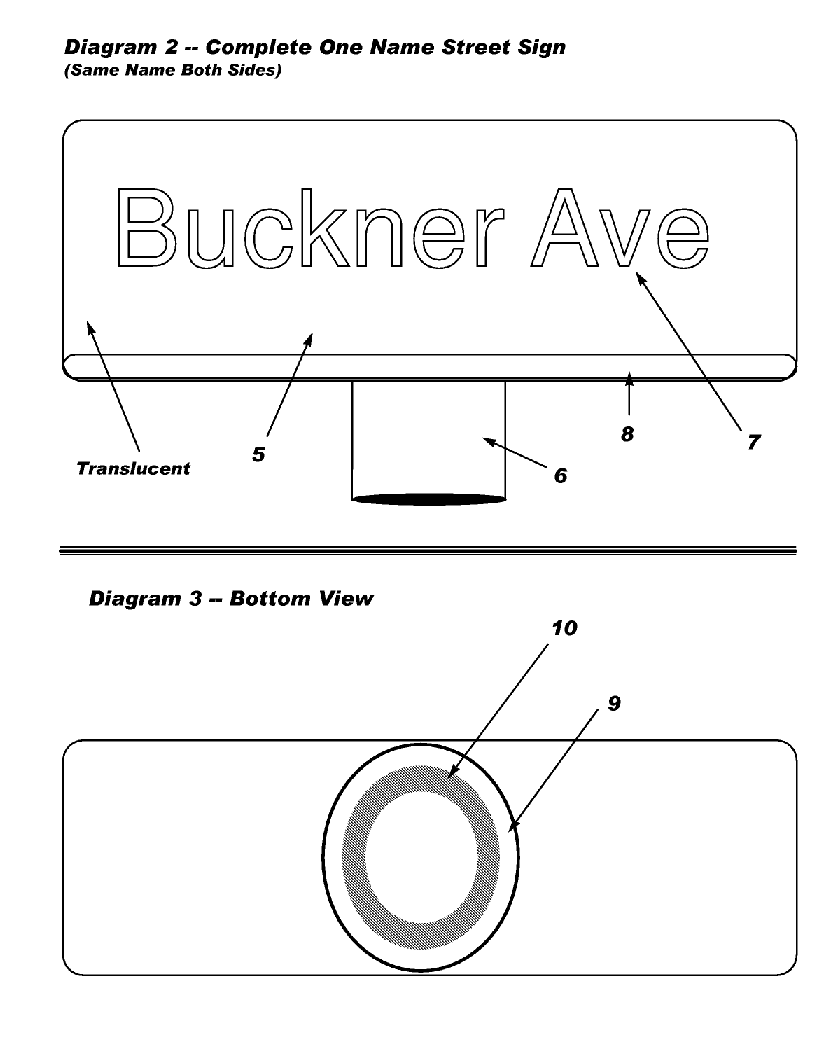

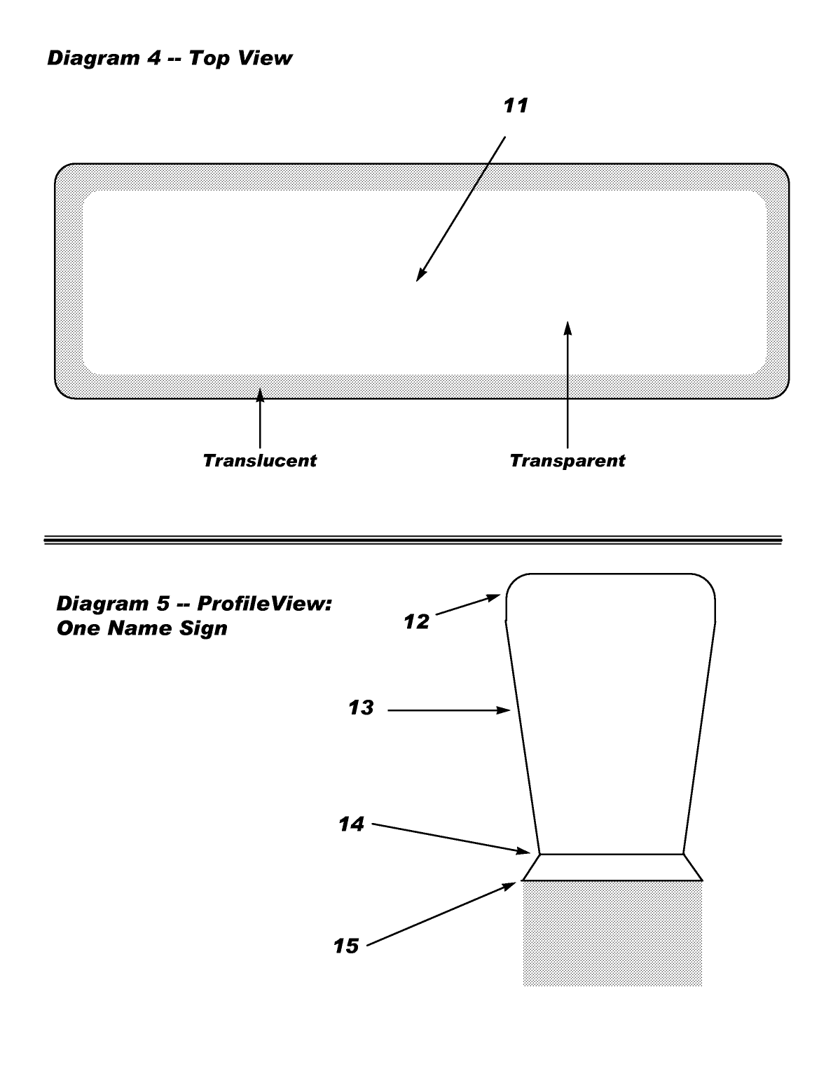

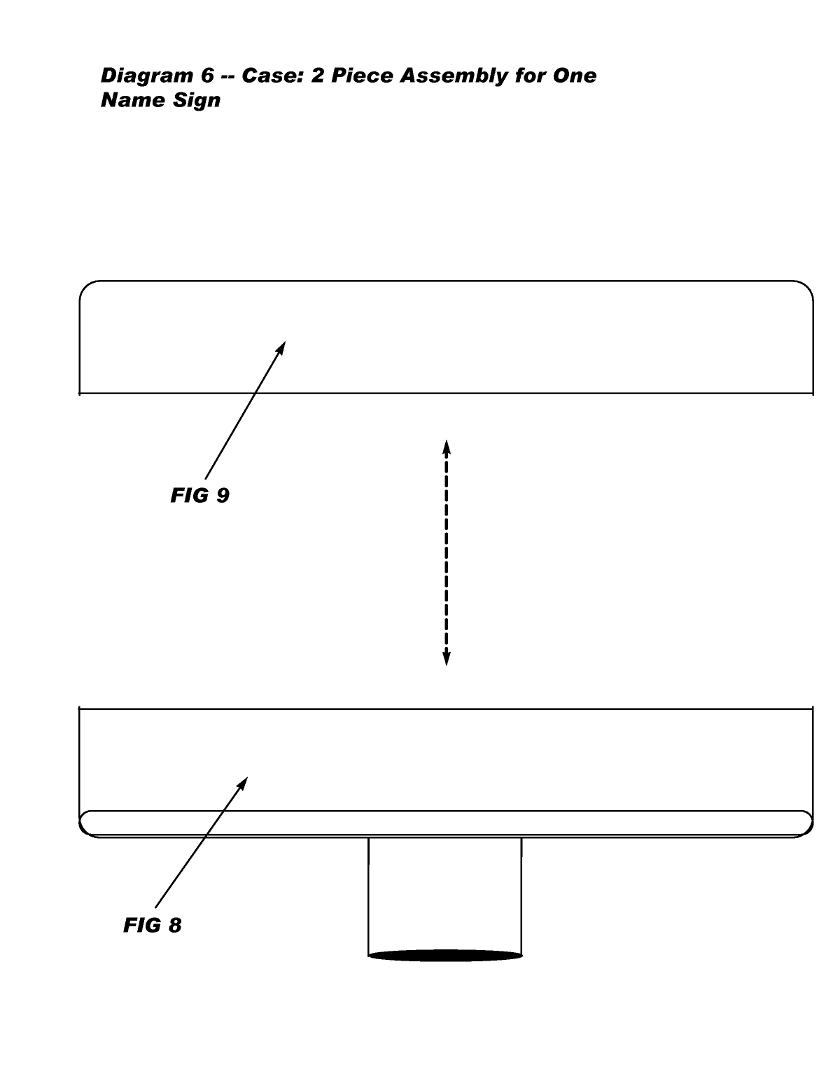

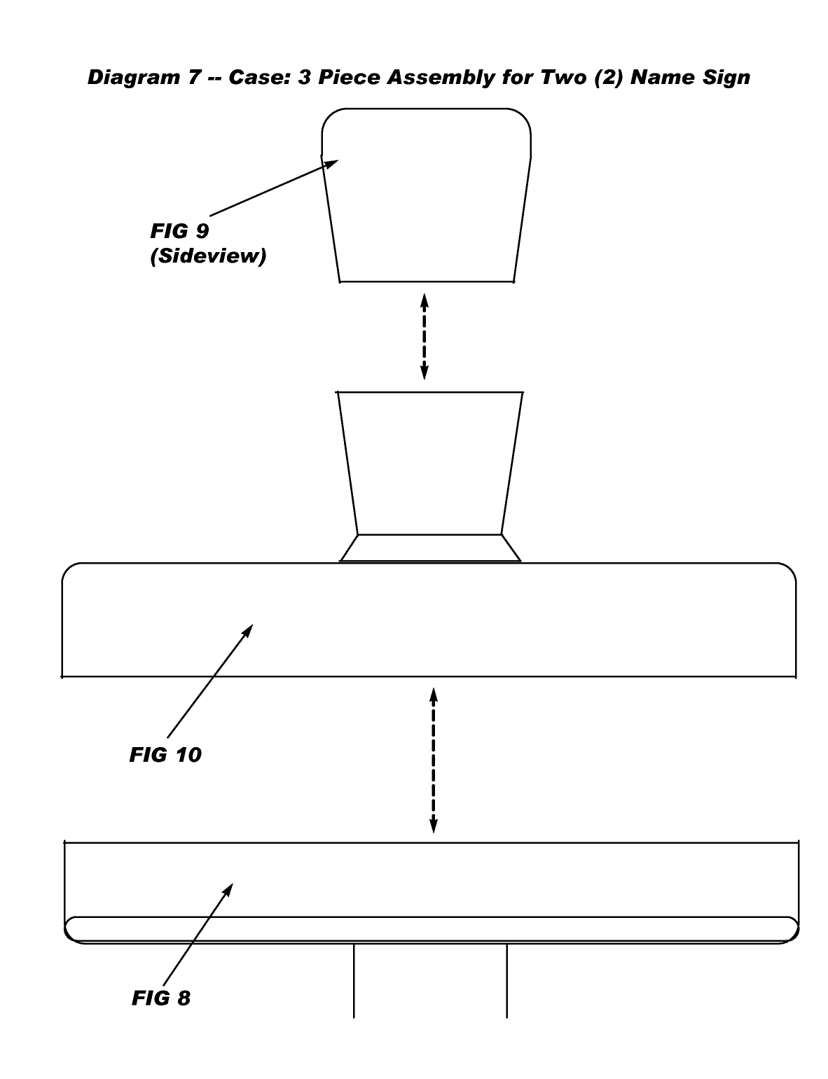

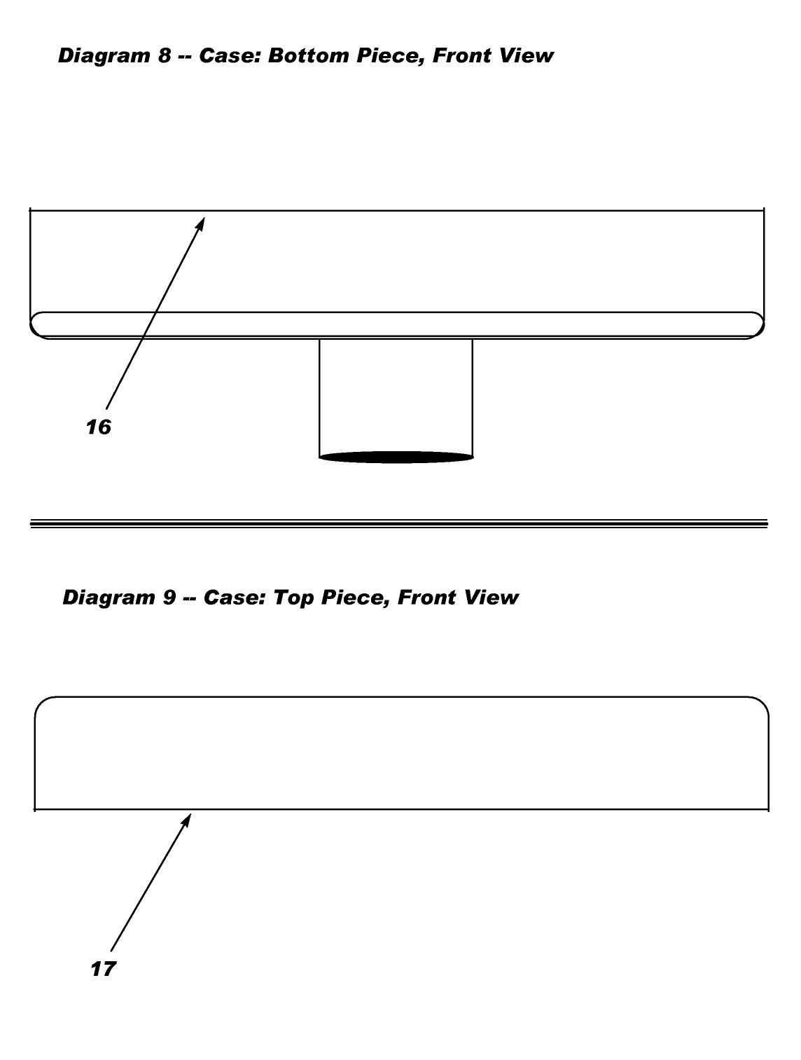

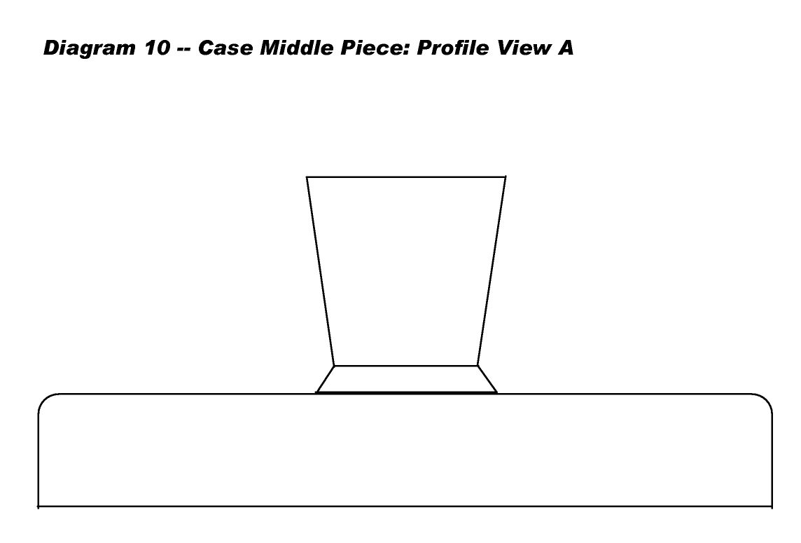

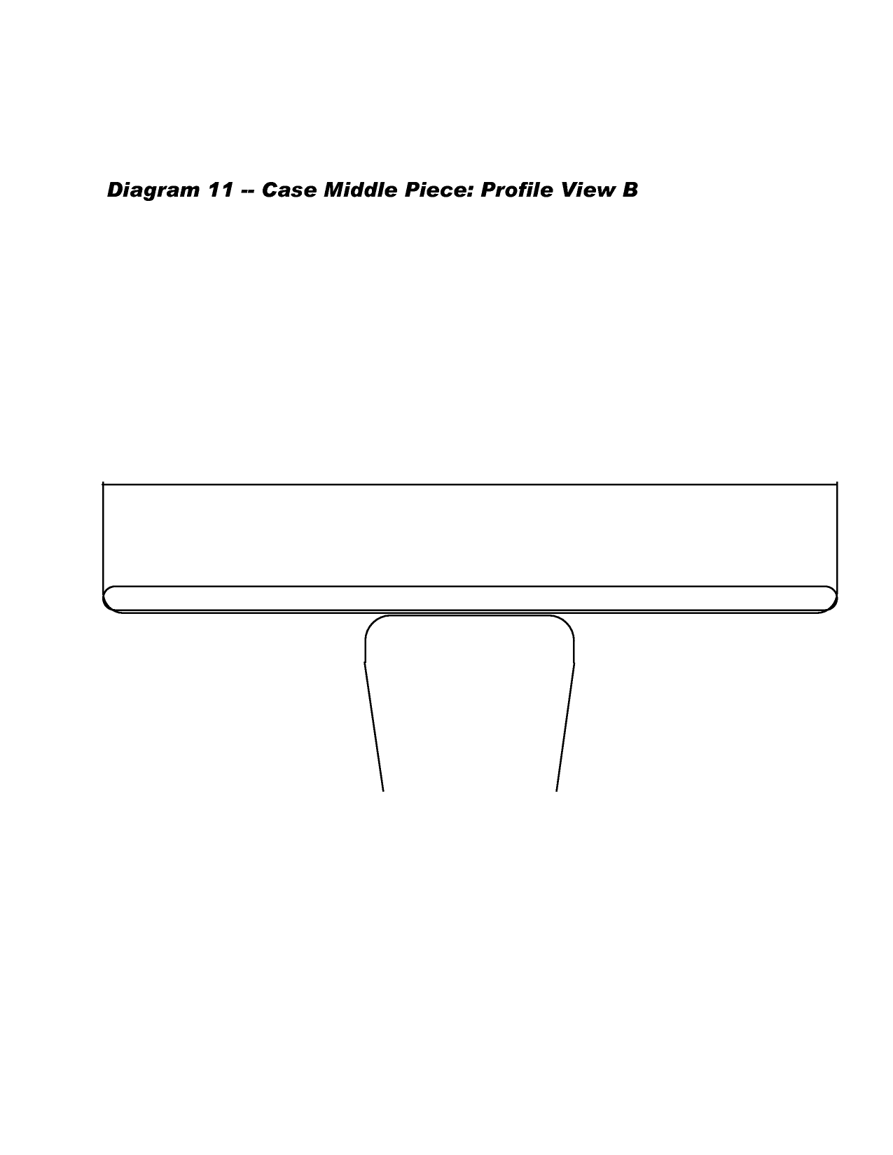

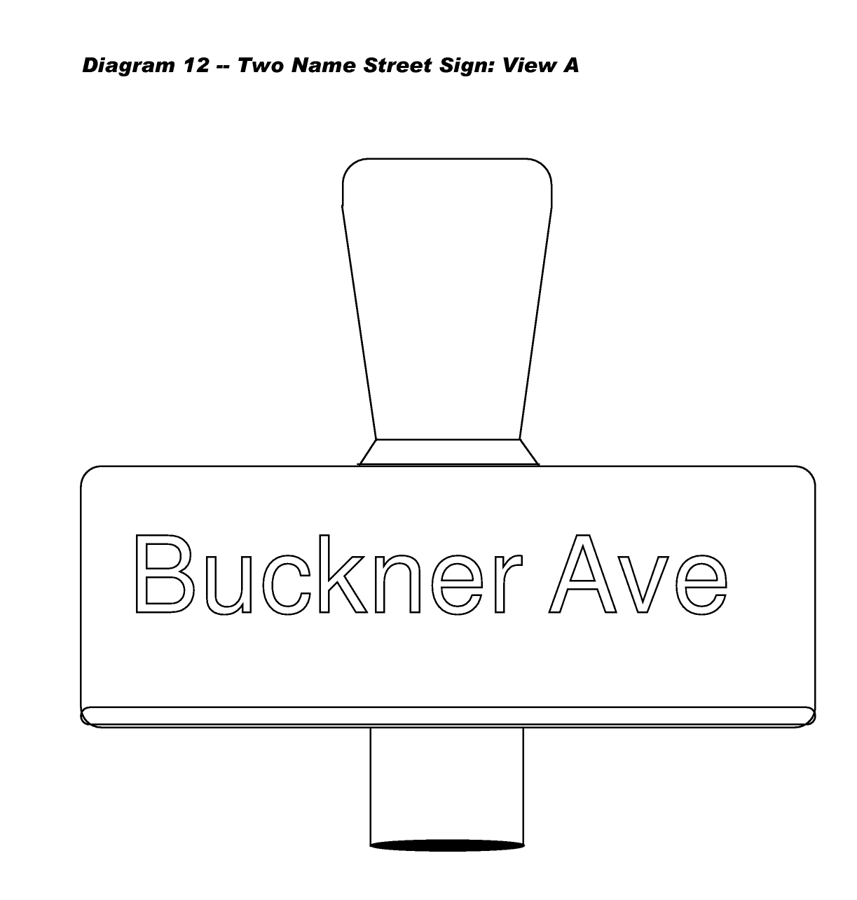

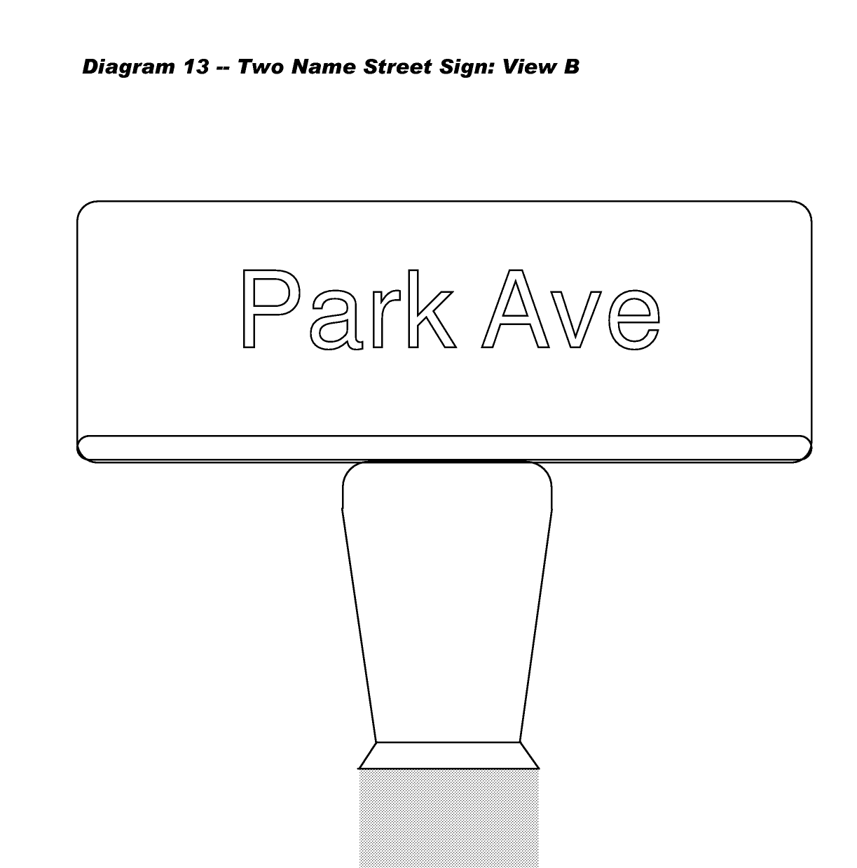

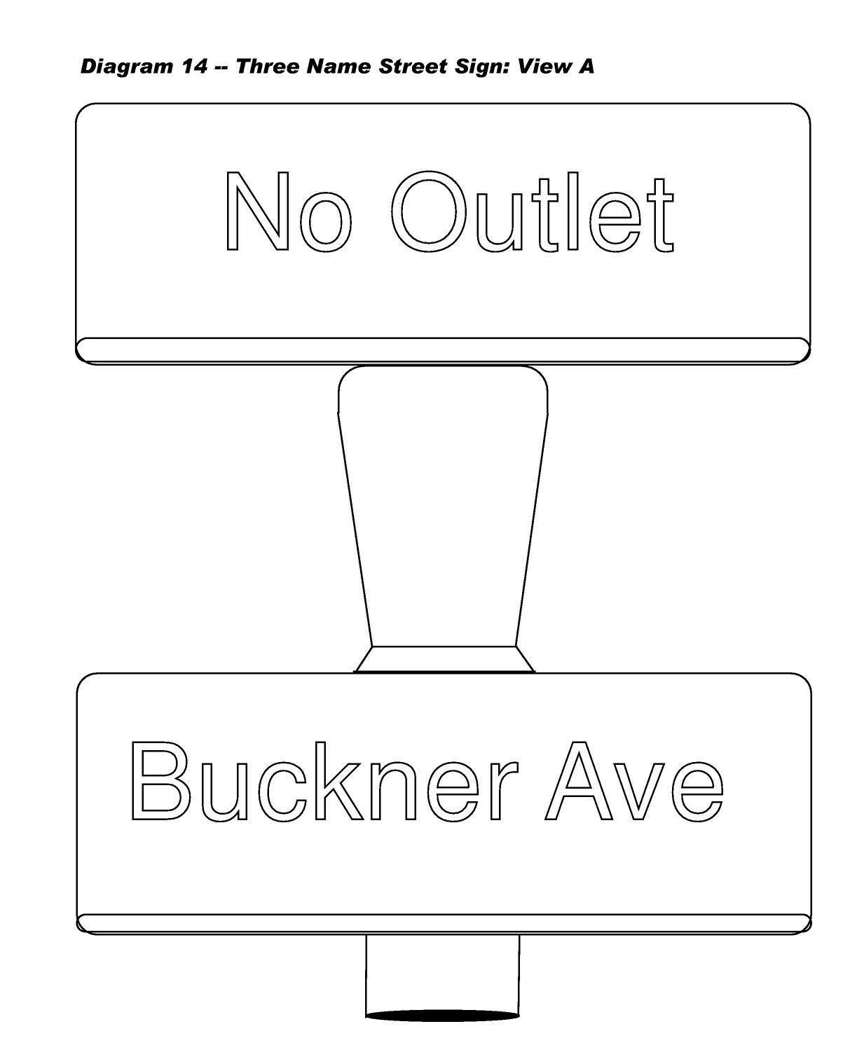

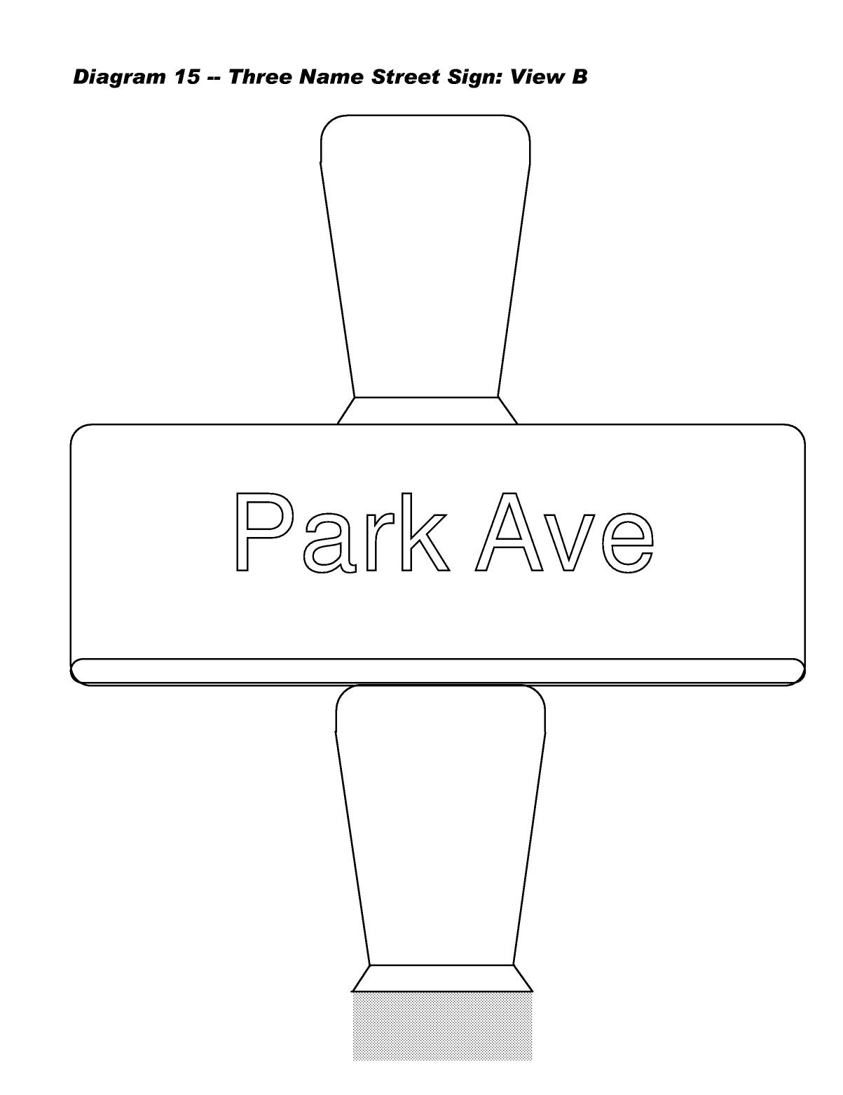

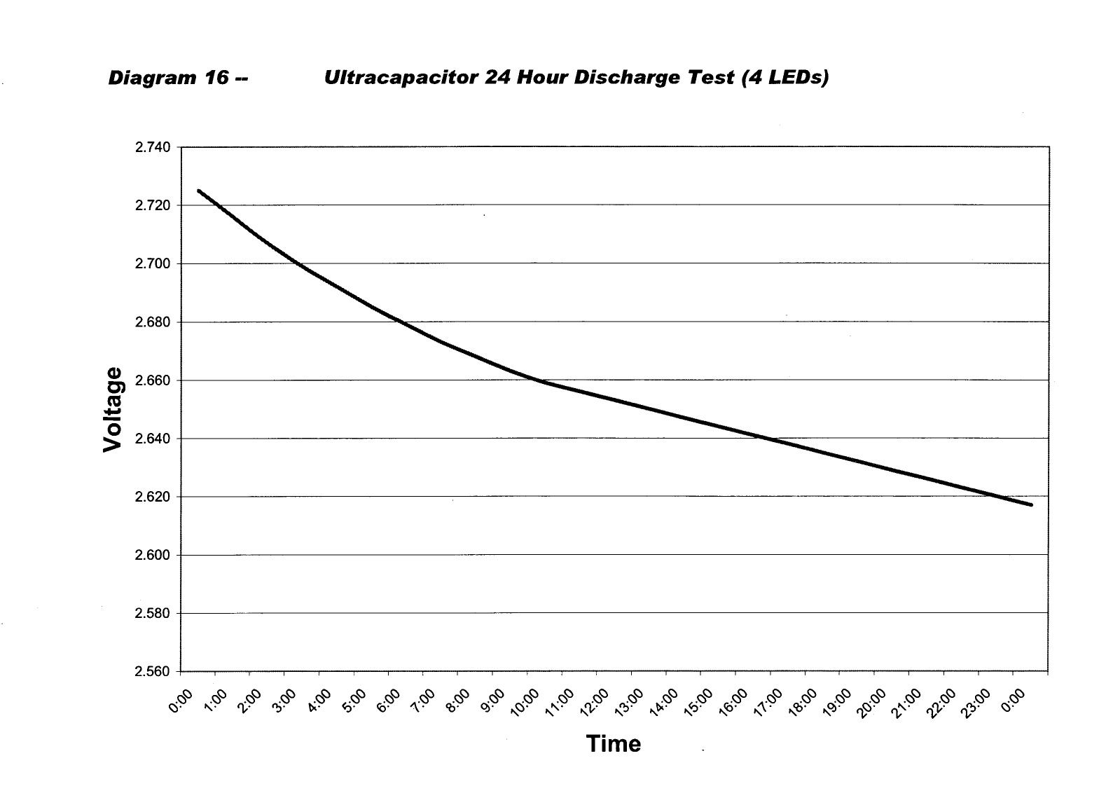

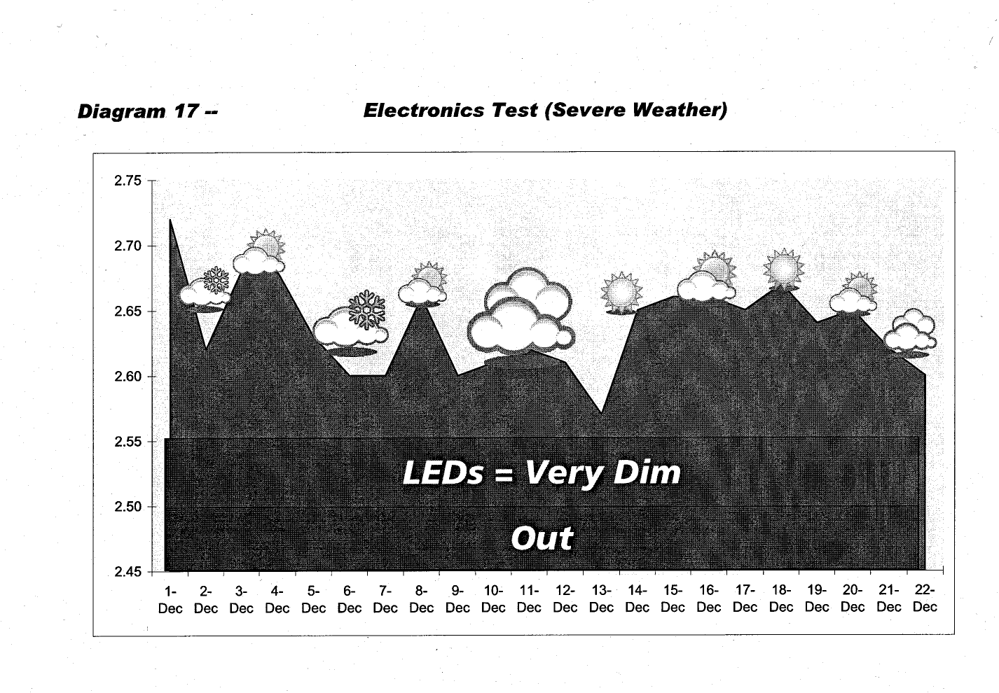

A case made of durable materials configured to a sign shape and a specific depth for one or many solar panels, in multiple pieces to allow assembly of all electronics inside and permanently sealed in a manner to prohibit access to components inside held safe from weather, animals, vandals etc. With only three pieces, the invention easily provides three corner street sign configurations for when one, two or three names are required. Without human intervention required it can be reasonably distributed in large numbers or in remote areas or both.

Zero Maintenance Solar Powered Street Sign—David A Neeff, NJ, U.S. Provisional Appl. #60/936,904—a lighted corner street sign using: solar panel film, ultracapacitors and LEDs where it contains no batteries, switches, sensors, etc. so the sign does not require maintenance for 10 years. Also a case design with three unique permanently sealed case pieces provides three sign configurations for when one, two or three street names are required.

### REFERENCES CITED

US Patent Documents:

| | | |
|---|---|---|
| 6,604,840 B2 | August 2003 | Watson |

### STATEMENT REGARDING FEDERALLY SPONSORED RESEARCH OR DEVELOPMENT

Not applicable

### BACKGROUND OF THE INVENTION

Prior art in solar lighting devices in general and solar-lighted signs in particular (ex. U.S. Pat. No. 6,604,840, Watson) deploy batteries along with other electronics such as: photoelectric sensors, switches, resistors, etc. When these components fail they need repairing or replacement. The need to replace parts requires complicated housings to gain access to each electronic part.

Most importantly, all conventional batteries need to be replaced every 2-3 years. This is significant for some applications (Watson). For example, 500 street signs in one town could require more than 5,000 new batteries over a ten-year period. These sporadic failures are not only costly in materials but chaotic and time consuming for a local maintenance department.

Therefore it is desirable to have a sign that can be lit using its own solar power that does not include any of the current battery technologies (Watson). Ultracapacitors provide the electrical storage a sign functionally requires and current ultracapacitor technology offers at least a 7-10 year expected life span.

It is desirable to minimize maintenance by using the fewest number of parts while maintaining functionality. This invention does both by using only three (3) electronic components: solar panel film, ultracapacitors, and light emitting diodes (LEDs). Functionally, the lights are lit all the time. Prior art (Watson) uses extra, complicated electronic parts, such as a photo-sensor, when compared to this invention. Complicated electronic components within hundreds of installed signs will fail and cause frequent unscheduled repairs.

Batteries also require the device to be open or require methods to access the batteries for replacement. For public use, it is desirable for the electronics to be sealed from weather, vandals, etc. This invention permanently seals access to the electronics.

It is desirable to be compatible with unlimited graphic signage options. This invention allows for new and current graphic possibilities. Rather than mount on an existing sign (Watson), this invention offers a turn-key solution including all electronics, more modern graphics, as well as, necessary clamps, screws, etc. to adapt to existing pole and supports.

### BRIEF SUMMARY OF THE INVENTION

This invention consists of a series of components that create a complete back-lit, corner street sign. The primary criterion for this device is: “zero maintenance for 7-10 years.” The sign is configured so that all electronics will be sealed secure inside the case. The major components are: Electronic Circuit, Case, Graphics.

Description of each component:
1. Electronic Circuit
There are only three electronic devices and they are connected in a very simple circuit. The circuit includes thin solar panel film(s) connected to ultracapacitor(s) and light(s). The lights are lit at all times with electricity from either the solar panel or ultracapacitor. The “always-on”strategy lights the sign at all times and provides long-term reliability via simplicity. Without the need for maintenance, all electronics can be completely sealed in the case. This circuit has been tested outdoors and works under all conditions including severe weather. Each electronic device is rated to function continuously for at least seven (7) years by its manufacturer.
2. Case
Intersections require a multitude of sign configurations and the ability to fit existing supports. There are three (3) unique molded components. The pieces of the case are divided in a horizontal orientation. This provides access during manufacturing to install the electronics, and allows the fewest molds in creating the various configurations. Individual case pieces will be clear in some areas and translucent in others. This allows light in for the solar panel and emits light out through the graphics.
The case will be constructed for each intersection with 2, or 3 pieces put together after the electronics are placed inside. A metal ring will be molded into the bottom with tamper proof screws added to attach the sign to existing support poles at street corners.
3. Graphics
Back-lit graphics will provide customers the flexibility to chose their own custom themes using various colors, typefaces and artwork. The lights will be placed inside the case behind the graphics and will illuminate either the image or non-image area. PVC-based graphic materials are highly durable and will last over 7 years as described by the manufacturer.

### BRIEF DESCRIPTION OF DIAGRAMS

Diagram 1—Electronic Circuit: an embodiment of this invention shown as an example where a circuit includes any number of permutations of various quantities of solar panels 1, ultracapacitors 3 and LEDs 4.

Diagram 2—Complete One Name Street Sign (Same Name Both Sides) an embodiment of this invention shown from the front perspective.

Diagram 3—Bottom View of same embodiment in Diagram 2.

Diagram 4—Top View of same embodiment in Diagram 2.

Diagram 5—Profile View: One Name Sign with a side view of same embodiment in Diagram 2.

Diagram 6—Case: 2 Piece Assembly for One Name Sign of same embodiment in Diagram 2 before assembly.

Diagram 7—Case: 3 Piece Assembly for Two (2) Name Sign of embodiment in Diagram 12-13 before assembly.

Diagram 8—Case: Bottom Piece, Front View: used for same embodiment in Diagram 2.

Diagram 9—Case: Top Piece, Front View: used for same embodiment in Diagram 2.

Diagram 10—Case Middle Piece: Profile View A: used for same embodiment in Diagram 12-13.

Diagram 11—Case Middle Piece: Profile View B: used for same embodiment in Diagram 12-13.

Diagram 12—Two Name Street Sign: View A

Diagram 13—Two Name Street Sign: View B

Diagram 14—Three Name Street Sign: View A

Diagram 15—Three Name Street Sign: View B

Diagram 16—Ultracapacitor 24 Hour Discharge Test (4 LEDs) representing test results of the embodiment of this invention roughly depicted in Diagram 1.

Diagram 17—Electronics Test (Severe Weather) representing test results of the embodiment of this invention roughly depicted in Diagram 1.

### DETAILED DESCRIPTION OF THE INVENTION

An electronic circuit is an embodiment of this invention and is shown as an example (DIA1) where a circuit includes any number of permutations of various quantities of solar panels 1, ultracapacitors 3 and LEDs 4. This invention's solar powered electronic circuit, referring to (DIA1), is simply: the solar panel(s) 1 connected to the ultracapacitor(s) 3 and the LED(s) 4 by connecting the positive poles together with wire and then separately connect the negative poles of each device with wire. An optional diode 2 can be connected coming from the solar panel(s). The number of ultracapacitors 3 depends on the desired number of LEDs 4 and the number of solar panels 1 depends on the required number of ultracapacitors 3. A parallel circuit is described herein and preferred while a series circuit is also functional herein.

This invention is based on state-of-the-art technology in these specific areas of electronics and the invention in whole and its parts have proven to work in live testing as described herein.

A solar panel 1 is selected based on its ability to withstand Ultraviolet (UV) light exposure for at least 7-10 years and being light in weight per electricity (mA) produced. The ultracapacitor 3 is selected based on its useful life expectancy to be at least 7-10 years and its weight per mA produced. The type of LED 4 is central to rest of the circuit. LEDs are selected for the most lumens with the smallest mA drawn.

Observations of the circuit (DIA1) are that the LEDs 4 can be left on all the time with the solar panel(s) 1 providing enough electricity (mA) to re-charge the ultracapacitors 3 to the maximum charge and simultaneously light the LEDs. It is believed that the LEDs 4 begin to draw power from the ultracapacitors 3 when the voltage from the solar panels 1 drops below required voltage to drive the LEDs 4. At dawn or whenever the voltage from the solar panel 1 rises above the required voltage to drive the LEDs 4, then extra power is diverted back to the ultracapacitors 3 to re-charge them. Testing observations and live testing results (DIA16-17) appear to substantiate these statements. The invention provided excellent test results under severe winter weather conditions when configured similar to shown in DIA1.

This invention is proven and achieves the functionality of lighting a sign at all times based on using solar power without the need for any batteries, photoelectric sensors, switches, resisters, etc.

Also embodied in this invention is the case (DIA2) described herein to hold said electronics (DIA1) in such a fashion as to expose the solar panels 1 to sunlight and to position the LEDs 4 throughout the case to provide sufficient light throughout the case to provide even dispersed lighting behind the graphics. Another embodiment of this invention is that parts of the case DIA 2 are translucent 5 in areas and transparent in others 11.

The case (DIA2-4) is dimensionally sized to accommodate the electronics, wide at the top (DIA4) to install the solar panel 11, and wide and high (DIA2) 5 to accommodate graphic images 7 then wide at the bottom (DIA3) to accommodate a pole adapter 9.

Pole adapter 6 is sized in height to firmly hold the sign on the pole and the case 9 is sized wide enough to accommodate the widest diameter pole possible. An optional variable size diameter metal sleeve 10 is molded into the case bottom to accommodate various pole diameters.

From the profile view of a sign (DIA5) an embodiment is said case is tapered from the top 12 that accommodates the solar panel 1 down to a smaller width 14 and then back to a wider width 15 to accommodate the pole adapter 6. The case face 13 is angled for the graphics 7 to face downwards towards the ground at a six (6) degree angle off center. Inside the case a width 13 is sized to accommodate electronics (DIA4). Said case (DIA2) has a flare 8 along the front bottom of the case area 5 as a result of the angle from 14 to 15, and said flare is on both faces of the sign.

An embodiment of this invention affixes a “film”, containing graphics in color or black and white, that blocks or filters light from the case in the image or non-image area, securely and permanently to the case in a general position 5 to display the specific data, generally the same on each side but different on each sign module, to provide information to passersby during daytime and nighttime. The specific use of particular typefaces, size, style, mode, color, art, logos, etc. to display or depict said information on said “film” is not an embodiment of this invention.

This invention seals the electronic parts away from weather, animals, humans, etc. from being stolen, worn, broken, or otherwise made inoperable in whole or in part by assembling and physically and permanently closing shut the pieces of said case.

As part of the embodiment of this invention is three (3) optional configurations for “one name” (DIA2), “two name” (DIA 12-13) and “three name” (DIA 14-15) street signs. This invention minimizes the required pieces to create such cases to three (3). Further embodiments include three (3) case pieces derived in shape and size from (DIA2) and (DIA 12) and subdivided in a horizontal fashion so that each piece can be manufactured separately with only three processes and allow access during assembly for installation of the electronics and then allow 2 or 3 of the pieces (DIA8-10) to be assembled such as shown in (DIA6-7) in three (3) optional configurations (DIA 2, 12-15.)

A preferred embodiment within this invention is a single name street sign (DIA2) that accommodates electronic devices 1-4 inside and displays graphics 7 outside made using two pieces: a bottom case piece (DIA8) and a top case piece (DIA9.)

An embodiment is a two name street sign (DIA 12-13) that accommodates electronic devices 1-4 inside and displays graphics 7 outside made using three (3) pieces: a bottom case piece (DIA 8), a middle piece (DIA 12-13) and a top case piece (DIA9.)

A preferred embodiment is a three name street sign (DIA 14-15) that accommodates electronic devices 1-4 inside and displays graphics 7 outside made using four (4) pieces: a bottom case piece (DIA8), a middle piece (DIA 12-13), a second middle piece (DIA 12-13) and a top case piece (DIA9.)

1. A lighted sign that illuminates graphic materials with specific electronic components, solar panel film, ultracapacitors and LEDs that provide a complete sign that does not require electronic or any such maintenance for 7 years, with said lighted sign device consisting of:
A translucent case made of durable materials assembled with all electronics inside in an arrangement that provides light for attached graphic materials;
solar film panel(s) configured to such a size and arranged in a direction to collect sufficient electricity;
One or several ultracapacitors connected to said solar panels to store sufficient electricity;
One or several light emitting diode(s) LEDs) arranged in a way to provide sufficient lumens in an even amount throughout the sign;
Electronic Circuit: an embodiment of this invention shown as an example in DIA 1 where a circuit includes any number of permutations of various quantities of solar panels 1, ultracapacitors 3 and LEDs 4
With all said electronic components matched and connected in a circuit to provide light at all times, under severe conditions, uninterrupted for 7 years.
With all said components, electronic or otherwise, having no requirement for periodic maintenance and each with an expected life span of 7 years.

2. A lighted corner street address sign, as in claim 1, that illuminates graphic materials from behind, within a translucent case with specific electronic components, solar panel film, ultracapacitor(s) and LED(s), that provides a complete sign but does not require electronic or any related maintenance for 10 years, and said sign can reasonably be distributed in great numbers or in remote areas or both with no maintenance requirements, with said lighting device consisting of:
A sealed case made of durable materials configured to form a sign shape and a specific depth for one or many solar panels, manufactured in multiple pieces to allow the assembly of all electronics inside and be permanently sealed in a manner to prohibit access to said components inside;
Said case provides lighting behind graphic materials attached to the outside of the case comprised of custom graphics for each sign installation, made of durable materials permanently adhered to the case with strong adhesive, that block light coming through the sign in either the image or non-image area;
With said case configured with adapters, connectors, screws, etc. to be attached to an existing pole or other physical supporting device;
UV resistant, and durable solar film panels configured inside the sign case under clear material and configured in such a size and arranged in a direction to collect electricity to provide sufficient current to the ultracapacitors while also providing electricity to light the LED(s);
One or several ultracapacitors connected to said solar panels to collect and store electricity when solar power is available and then provide electricity to LED(s) when insufficient solar electricity is available;
One or several LEDs configured inside the sealed case arranged in a way to provide sufficient lumens in an even amount dispersed throughout the translucent case, said LEDs are lit continuously providing light for signage at all times under all conditions, uninterrupted for 10 years;
Each of the said electronic components, solar panel(s), ultracapacitor(s) and LEDs, being uniquely matched and connected in a circuit providing electricity to the lights continuously without requiring photo-sensors, switching devices, resistors, transistors, etc. to manage electricity storage, provide consistent current, limit light emission or to resolve any other prior concerns with devices of this type;
With all said components, electronic or otherwise, having no requirement for periodic maintenance and each with an expected life span, under any weather conditions, of over 10 years.
With all said electronic components matched and connected in a circuit to provide light at all times, under severe conditions, continuously for 10 years.

3. A lighted corner street address sign, as in claim 1, that illuminates graphic materials from behind, with only three (3) unique case pieces, that provides three (3) permutations of complete corner street signs for scenarios when one, two and three names are required, said sign configured with specific electronic components, solar panel film, ultracapacitor(s) and LED(s) but said sign does not require electronic or any related maintenance for 10 years, and said sign can reasonably be distributed in great numbers or in remote areas, or both, with no maintenance requirements, with said lighting device consisting of:
Two or three unique case pieces, made of durable materials, translucent in areas, transparent in others, molded in shapes to support the bottom, middle (optional) and top of the completed sign, and assembled using different plans to supply one, two or three street name configurations;
A said top case piece forms a portion of the sign shape with a specific dimension for one or many solar panels with a transparent area to allow for the sunlight to affect the solar panel assembled inside the case and with a corresponding fixed shape to connect to either a bottom or middle case piece;
A middle case piece forms the portion of the bottom of the top street sign and then the bottom portion of the middle piece forms the top of the bottom street sign in an X configuration and is a fixed shape and size to fit both the top case piece and the bottom case piece;
A bottom case piece forms the bottom of said case with a pole shaped adapter molded within the piece to be attached to an existing pole or other physical supporting device and that is a fixed shape and size to fit both the top case piece or the middle case piece;
Said multiple piece case with assembly of all electronics inside is permanently sealed in a manner to prohibit access to said components inside;
Said case provides lighting behind graphic materials permanently attached to the outside of the case, said custom graphics for each sign installation, made of durable materials permanently adhered to the case with strong adhesive, block light coming through the sign in either the image or non-image area;
UV resistant, and durable solar film panels configured inside the sign case under clear material and configured in such a size and arranged in a direction to collect electricity to provide sufficient current to the ultracapacitors while also providing electricity to light the LED(s);
One or several ultracapacitors connected to said solar panels to collect and store electricity when solar power is available and then provide electricity to LED(s) when sufficient solar electricity is not available;
One or several LEDs configured inside the sealed case arranged in a way to provide sufficient lumens in an even amount dispersed throughout the translucent case, said LED(s) are lit continuously providing light for signage at all times under all conditions, uninterrupted for 10 years;
Each of the said electronic components, solar panel(s), ultracapacitor(s) and LEDs, being uniquely matched and connected in a circuit providing electricity to the lights continuously without requiring switching devices, resistors, transistors, sensors, etc. to manage electricity storage, provide consistent current, limit light emission or to resolve any other previous concerns with devices of this type;
With all said components, electronic or otherwise, having no requirement for periodic maintenance and each with an expected life span, under any weather conditions, of over 10 years.
With all said electronic components matched and connected in a circuit to provide light at all times, under severe conditions, continuously for 10 years.
